(19) United States
(12) Patent Application Publication
(10) Pub. No.: US 2009/0301879 A1
(43) Pub. Date: Dec. 10, 2009

(54) PROTECTIVE COATINGS FOR SOLID-STATE GAS SENSORS EMPLOYING CATALYTIC METALS

(76) Inventors: Prabhu Soundarrajan, Valencia, CA (US); An T. Nguyen Le, Stevenson Ranch, CA (US); Todd E. Wilke, Minneapolis, MN (US)

Correspondence Address: MCANDREWS HELD & MALLOY, LTD, 500 WEST MADISON STREET, SUITE 3400, CHICAGO, IL, 60661, US

(21) Appl. No.: 12/419,152

(22) Filed: Apr. 6, 2009

Related U.S. Application Data
(60) Provisional application No. 61/042,755, filed on Apr. 6, 2008.

(51) Int. Cl. G01N 27/26; C01B 33/12; B32B 27/06; B05D 3/02

(52) U.S. Cl. 204/431; 423/335; 428/421; 427/374.1

(57) ABSTRACT

A protective coating sustains the long term performance of a solid-state hydrogen sensor that includes a catalyst layer for promoting the electrochemical dissociation of hydrogen. The catalyst is susceptible to deterioration in the presence of at least one contaminant, including carbon monoxide, hydrogen sulfide, chlorine, water and oxygen. The coating comprises at least one layer of silicon dioxide having a thickness that permits hydrogen to diffuse to the catalyst layer and that inhibits contaminant(s) from diffusing to the catalyst layer. The preferred coating further comprises at least one layer of a hydrophobic composition, preferably polytetrafluoroethylene, for inhibiting diffusion of water through the protective coating to the catalyst layer. The preferred protective coating further comprising at least one layer of alumina for inhibiting diffusion of oxygen through the protective coating to said catalyst layer. In manufacturing the protectively-coated sensor, the silicon dioxide layer is preferably annealed.

### CROSS-REFERENCE TO RELATED APPLICATION(S)

This application relates to and claims priority benefits from U.S. Provisional Patent Application Ser. No. 61/042,755, filed Apr. 6, 2008, entitled “Protective Coatings for Solid-State Gas Sensors Employing Electrocatalysts Susceptible to Contamination”. The '755 provisional application is hereby incorporated by reference in its entirety.

### FIELD OF THE INVENTION

The present invention relates to sensors for detecting the presence of a constituent in a fluid (gas or liquid) stream. More particularly, the present invention relates to protective coatings for solid-state sensors that employ catalytic metals to detect the presence of a constituent, particularly hydrogen, in a fluid (gas and liquid) stream comprising a mixture of constituents that would have detrimental reactions with the sensor.

### BACKGROUND OF THE INVENTION

Gas sensors, more specifically solid-state hydrogen sensors, are frequently employed in applications with constituents that can react with the catalytic metal of the sensor, such as hydrocarbons and contaminants like carbon monoxide (CO), hydrogen sulfide (H₂S), chlorine (Cl₂) and chlorine are present. Because the presence of such contaminants degrades the performance of solid-state hydrogen sensors employing catalytic metals, protective coatings can be employed to prevent or ameliorate sensor performance degradation.

As used herein, the term “solid-state” refers to a component, device and/or system (such as a transistor) in which electrical current is confined to solid elements and compounds that are capable of conducting, switching and amplifying the current.

In this application, all percentages and parts-per-million (ppm) concentrations are by volume

Protective coatings can enable direct hydrogen measurements with consistent performance and sensor operation in applications including but not limited to:
(a) Continuous monitoring hydrogen levels in petroleum refineries, hydrotreating facilities, hydrogen production and storage facilities in which high concentration backgrounds of up to 20% carbon monoxide (CO), 1000 ppm hydrogen sulfide (H₂S) and other deleterious contaminants affecting sensor operation. For example, CO blocks the sensor surface and reduces response time; H₂S poisons the sensor surface and permanently damages the sensor.
(b) Accurate monitoring of hydrogen in chlorine manufacturing facilities in high concentration backgrounds of greater than about 99% wet chlorine.
(c) Dissolved gas analysis of hydrogen in oil-filled electrical equipment, such as a transformer, by direct immersion of the sensor in hydrocarbon oils.
(d) Monitoring of hydrogen concentrations in assisted and non-assisted flares (See EPA flaring regulations are at 40 CFR 60.18 and 63.11.

In processing plants that produce hydrogen, such as refining plants (see, for example, Parias et al. U.S. Patent Application Publication No. 2006/0233701), storage facilities, hydrotreating facilities (see Cohen et al. U.S. Pat. No. 7,191,805), and hydrogen fuelling stations require hydrogen detectors that can accurate measure percentage levels of hydrogen in harsh background environments that include contaminants like CO, H₂S and Cl₂ at elevated temperatures. Palladium-based sensors have inherent instability in the presence of these contaminants at these higher temperatures and show considerable drift with contaminants such that sensor performance in detecting hydrogen is altered. Due to the drifts in contaminant backgrounds, the hydrogen sensors cannot be used reliably used for such process applications.

The present technique involves the application of protective coatings on the surface of sensors that employ catalytic metals such as palladium, platinum, ruthenium, vanadium and/or other precious/noble metal catalysts, and their alloys. The present technique also provides a process for manufacture of the coatings employed to improve the accuracy and performance of hydrogen detectors in harsh chemical process stream backgrounds that include contaminants like CO (a surface adsorbing/inhibiting chemical species), H₂S (a precious metal catalyst poison), Cl₂ (an electroactive species). The coating prepared according to the present technique is permeable to hydrogen (H₂; molecular weight (MW)=2) and inhibits contaminants with higher molecular weights, such as, for example, H₂S (MW=34) and CO (MW=28).

Hydrogen sensors, as well as sensors generally that are based on electrical transduction due to surface catalytic reactions, with the present protective coatings will enable multi-point hydrogen monitoring in chemical processes with varying backgrounds of harsh gases and temperatures. “Multi-point” monitoring refers to processes in which hydrogen is monitored at more than point in the process, as opposed to monitoring at a single point. “Harsh gases” are those that occupy surface sites and prevent or inhibit the penetration of H₂ into the Pd—Ni lattice. The present coatings inhibit contamination by preventing direct access of the harsh gases to the Pd—Ni catalyst surface—in essence it employs a size-selective inhibition mechanism.

The present technique also enables the stable operation of a solid-state palladium hydrogen sensor at elevated temperatures, included but not limited to applications between about 100° C.-150° C. in chemical process plants.

The annealing aspect of the present technique includes subjecting the sensor to elevated temperature in a background of one or more gases including hydrogen, nitrogen, oxygen, inert compounds (such as, for example, helium and argon) or combination(s) thereof.

Conventional, prior art techniques have failed to specifically provide accurate, contaminant-free detection of gaseous constituents, specifically H₂, especially over prolonged time periods.

Some inorganic and organic coatings have been cited in the technical literature to protect a hydrogen sensor surface from contaminants:

Plasma chemical vapor deposition (CVD) SiO₂ films for volatile organic compound (VOC) protection: Y. Wang et al., “Potential Application of Micro sensor Technology in Radioactive Waste Management with Emphasis on Headspace Gas Detection”, Sandia National Laboratory report, September 2004, page 59.

O' Connor et al. U.S. Pat. No. 6,634,213, issued in the name of Honeywell International Inc., describes the use of a hydrogen-permeable organic polymer coating for the purpose of protecting the sensor catalytic surface. The patent does not disclose protecting the sensor catalyst surface from penetration by contaminants.

Conventional, prior art sensor coating techniques have been unable to protect the sensor surface from the deleterious effects of prolonged exposure to contaminants such as CO and H₂S. Moreover, there have been no identified reports on techniques for increasing the stability of hydrogen sensors employing palladium-based (as well as other noble metal/alloy) catalysts by post-deposition processing such as by thermal annealing at temperatures greater than 300° C. in a background comprising one or more gases, such as, for example, H₂/N₂, inert gases and O₂.

The technical literature has also failed to provide test data on the long-term drift characteristics and influence of contaminants on gas sensor performance.

Prior art techniques also failed to demonstrate the effective inhibition or blockage of contaminant molecules via application of coatings on the sensor electrocatalyst surface.

Conventional, prior art sensors with coatings applied to their electrocatalyst surface(s) had very slow response times (greater than 100 seconds) to hydrogen, thereby making the sensors unsuitable or undesirable for many end-uses. Moreover, prior art coatings have not enabled long term performance by the sensor. Long term performance means weeks, months or years of continuous operation without measurable degradation of sensor performance.

### SUMMARY OF THE INVENTION

The foregoing and other shortcomings of conventional, prior art techniques for inhibiting detrimental reactions on the catalytic surfaces of gas sensors are overcome by a protective coating for sustaining performance of a solid-state sensor of a gaseous constituent. The sensor comprises a catalyst layer for promoting electrochemical dissociation of the gaseous constituent. The coating comprises at least one layer of silicon dioxide. The current coating enables long term performance by the sensor. Long term performance means weeks, months or years of continuous operation without measurable degradation of sensor performance.

In the case of a solid-state hydrogen sensor in which a catalyst layer promotes electrochemical dissociation of hydrogen molecules to hydrogen ions, a protective coating comprising at least one layer of silicon dioxide sustains performance of the sensor.

The present coatings and processes enhance resistance of sensor catalytic surfaces to contaminant molecules, including but not limited to electroactive compounds like CO, catalyst poisons like H₂S, corrosive gases like Cl₂, oxygen (O₂), water (H₂O), carbon dioxide (CO₂), acid chlorides like hydrochloric acid (HCl), inert gases like argon (Ar) and helium (He), aliphatic and aromatic hydrocarbons like methane (CH₄.), ammonia (NH₃), and mixed gas streams of these compounds (such as 100 ppm CO+100 ppm H₂S).

In the present technique, hydrogen specificity, stability and drift reduction of palladium-based solid-state hydrogen sensors is increased using protective coatings.

The present technique also provides methods for stable operation of palladium-based sensors at high temperatures (as high as 150° C.) in process plants, via a unique thermal annealing process.

The present technique also provides a thin film coating that inhibits the penetration of most contaminant gases other than hydrogen. The coating is formed via the evaporative or plasma-enhanced chemical vapor deposition of SiO₂ thin films over a hydrogen-sensitive material (such as palladium-nickel or other contaminant gas-sensitive material). The coating has been found not to negatively affect hydrogen sensitivity to a significant degree and limits the permeability of molecules larger than hydrogen.

The present technique also provides a “molecular stack” in which the coating is combined with materials including but not limited to Al₂O₃ and hydrophobic polytetrafluoroethylene (PTFE) using one or more deposition techniques to provide inhibition of penetration of water and/or oxygen molecules.

In an aspect of the present technique, a thermal annealing method increases the resistance to penetration for molecules larger than hydrogen.

### BRIEF DESCRIPTION OF THE DRAWING(S)

FIG. 1 is a process flow diagram showing the two-step process employed in the preparation of a coating for solid-state sensors, particularly hydrogen sensors, that inhibits penetration of contaminants in a gaseous stream. In this embodiment Coating 2 is at least 2 times the thickness of Coating 1.

FIG. 2 is a process flow diagram for the preparation of an improved barrier to contaminants, formed by increasing the thickness of the protective coating.

FIG. 3 is a process flow diagram illustrating the effect of the disclosed thermal annealing process on the penetration rate of O₂ on a palladium-nickel sensor surface.

FIG. 4 is a graph comparing the effects of applying Coating 1 and Coating 2 on the performance of a hydrogen sensor in a stream containing 300 ppm H₂S and approximately 10% H₂/N₂ mixture.

FIG. 5 is a graph comparing the effects of applying Coating 1 and Coating 2 on the performance of a hydrogen sensor in a stream containing 1000 ppm H₂S and approximately 10% H₂/N₂ mixture.

FIG. 6 is a graph showing the effect of Coating 1 on the performance of a hydrogen sensor in a stream containing 20% CO, 35% H₂, 2% N₂, 20% CH₄, and 23% CO₂ for 2 days.

FIG. 7 is a graph showing the response of a hydrogen sensor in humid air (95% relative humidity (RH) with 18% O₂) backgrounds with (i) Coating 1 (not thermally processed) and (ii) Coating 1 subjected to the thermal processing aspect of the present technique.

FIG. 8 is a graph showing the operation of a protected palladium-nickel hydrogen sensor while immersed in a hydrocarbon oil used to insulate electrical equipment.

FIG. 9 is a graph showing the effect of Coating 1 on the performance of a hydrogen sensor in a stream containing 90% H₂, 100 ppm CO and 100 ppm H₂S.

FIG. 10 is a graph showing the effect of Coating 1 on the performance of a hydrogen sensor in a stream containing 60% CO₂ and 2% CH₄.

### DETAILED DESCRIPTION OF PREFERRED EMBODIMENT(S)

Thin film coatings are applied to the catalytic surfaces of gas sensors to inhibit penetration of contaminant molecules.

### Example 1

### SiO₂ Coatings for Inhibiting H₂O, H₂S, CO, O₂ and Hydrocarbons

A coating based on evaporated SiO₂ thin film (hereinafter referred to as Coating 1) and a thermal processing technique (sometimes referred to herein as annealing) improve the conformity of the coating to inhibit contaminants and selectively allowing hydrogen permeation.

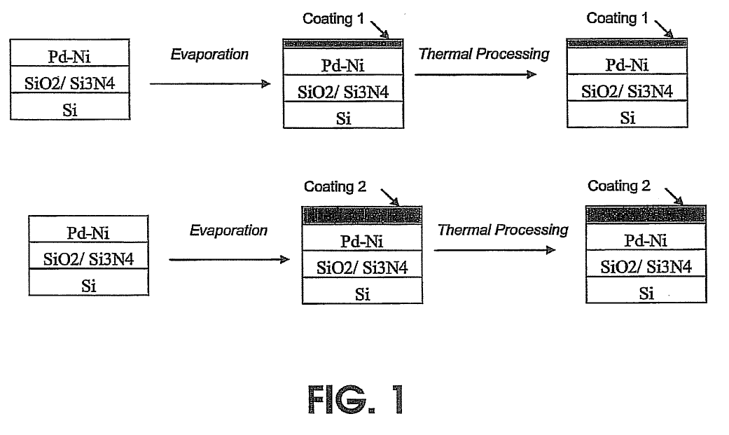

FIG. 1 shows the process for fabricating such a coating on the sensor. Coating 1 can be prepared by standard, known deposition techniques including thermal evaporation, chemical vapor deposition, plasma assisted chemical vapor deposition techniques.

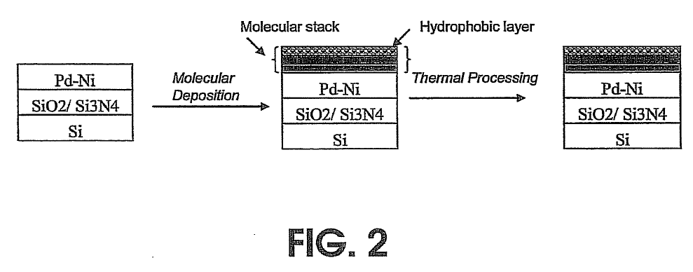

FIG. 2 shows a process for preparing an improved barrier to contaminants by increasing coating thickness. The processes to increase the thickness of the SiO₂ coating by thermal evaporation techniques are also known.

In the present technique, coating thickness can be selectively adjusted to limit permeation to contaminant molecules like H₂S, CO, H₂O, Cl₂, O₂, hydrocarbons and other compounds as previously described.

### Example 2

### Inorganic Coatings Comprising Al₂O₃, SiO₂ and Hydrophobic Coatings to Provide Additional Inhibition of H₂O and O₂ Penetration

The present technique also provides a molecular stack prepared by molecular vapor deposition that includes a hydrophobic layer to inhibit penetration of water molecules into the palladium-nickel hydrogen sensor surface. FIG. 2 shows the method of fabrication of the molecular stack over the sensor surface. In one embodiment, the molecular stack is built by depositing a layer of SiO₂ (10 Å-100 Å) followed by a hydrophobic layer (10 Å to 100 Å). A hydrophobic material like PTFE can be used with this embodiment.

### Example 3

### N₂ Anneal at 350° C. as a Method to Provide Additional Stability for a Solid-State Hydrogen Sensor Operation in Air

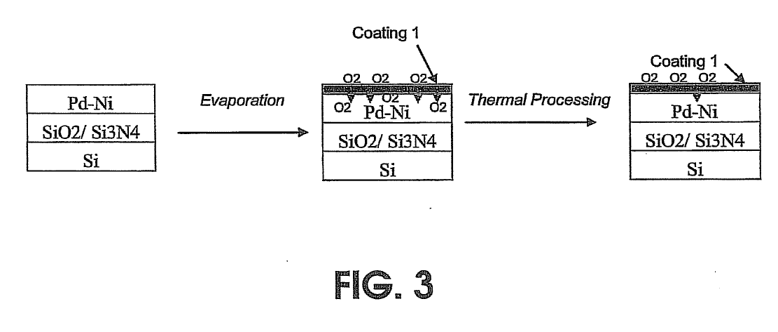

The present technique also provides an annealing process at 350° C. in nitrogen backgrounds with Coating 1 and Coating 2 to improve the conformity and stability of the coatings. “Conformity” refers to densification of the coating to provide a better barrier to contaminants. FIG. 3 indicates that the penetration of oxygen molecules into the Coating 1 is reduced after the thermal annealing process. A similar effect is observed with H₂S, CO, Cl₂ and hydrocarbons.

Hydrogen Sulfide (H₂S) Inhibition with Coating 2.

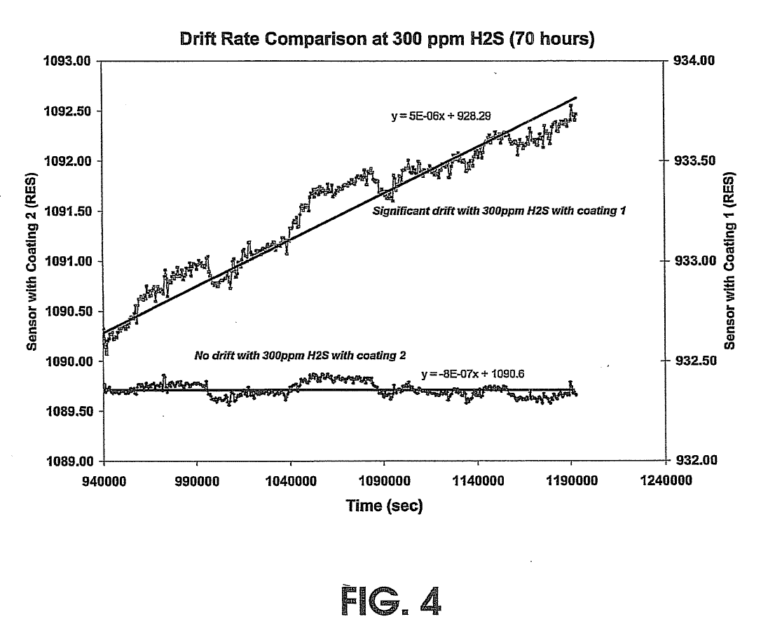

Coating 2 applied in accordance with the present technique has enabled the continuous operation of a palladium-nickel hydrogen sensor in 300 ppm H₂S backgrounds. FIG. 4 shows continuous operation of the hydrogen sensor detecting 10% H₂ for 70 hours in the presence of 300 ppm H₂S.

The functional and performance differences are illustrated in FIGS. 4-7.

As shown in FIG. 4, the present coating technique enables the drift free operation of a hydrogen sensor in the presence of 300 ppm H₂S. The drift in H₂S has been reduced at least by an order of magnitude for acceptable applications in process plants.

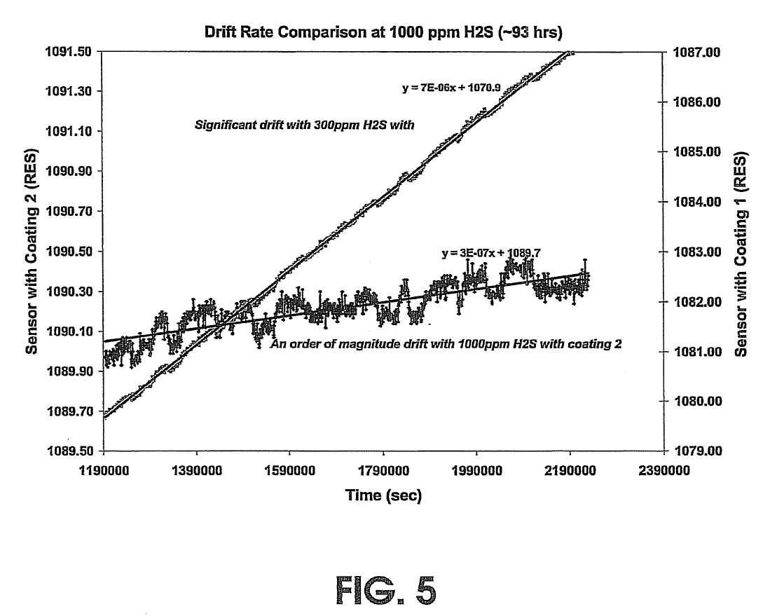

Referring now to FIG. 5, Coating 2 also enabled the continuous operation of a palladium-nickel hydrogen sensor in 1000 ppm H₂S backgrounds. FIG. 5 shows continuous operation of the hydrogen sensor detecting 10% H₂ for 93 hours in the presence of 1000 ppm H₂S. The present technique thus enables substantially drift-free operation of a hydrogen sensor in the presence of 1000 ppm H₂S. The drift in 1000 ppm H₂S has been reduced at least by an order of magnitude for acceptable applications in process plants.

Carbon Monoxide (CO) Inhibition with Coating 1.

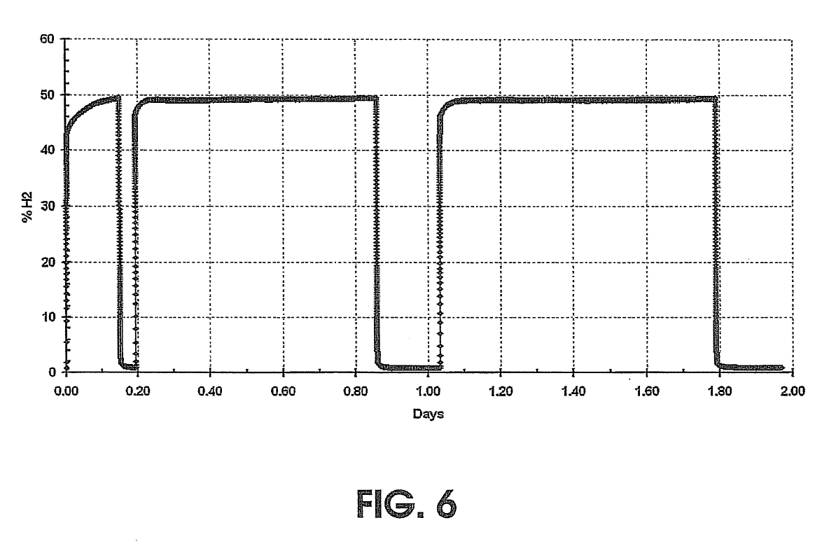

Coating 1 prepared according to the present technique also enables continuous operation of a palladium-nickel hydrogen sensor in 20% CO backgrounds. FIG. 6 shows continuous operation of the hydrogen sensor detecting approximately 35% H₂ for 2 days hours in the presence of 20% CO.

FIG. 6 thus demonstrates that the present technique enables the drift free operation of a hydrogen sensor in the presence of at least 20% CO, 20% CH₄, and 23% CO₂. The operation of the hydrogen sensor in these contaminant backgrounds enables trouble-free operation of the hydrogen sensor.

Oxygen (O₂) Inhibition and Enhanced Performance in Humidity (H₂O).

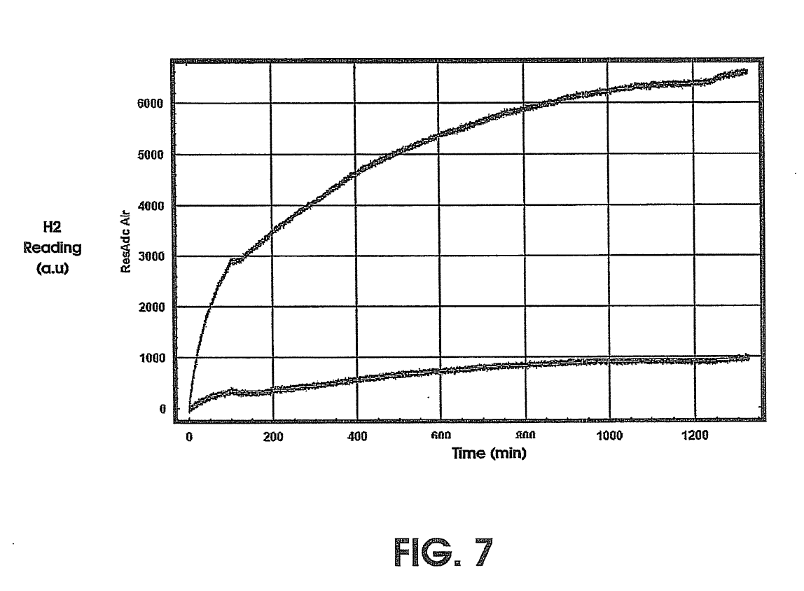

FIG. 7 shows the operation of a palladium-nickel hydrogen sensor showing a zero offset (defined as a reversible positive response in the absence of hydrogen). It is known that palladium-nickel hydrogen sensors can show a false positive signal with 0% H₂ in air backgrounds (less than 0.5% H₂/air; atmospheric air at ground level contains 0.5 ppm H₂) due to the zero offset. The upward drift is due to the reaction of oxygen on the sensor surface in the absence of hydrogen. The disclosed coating with the annealing process as shown in the figure reduces the “zero offset” at least by an order of magnitude. The coating and the process of the present technique enables operation of palladium-nickel hydrogen sensors without false alarms at less than 0.5% H2/air.

The present technique thus provides a process-hardened hydrogen sensor to replace or supplement analytical techniques like gas chromatograph, mass spectrometry, and thermal conductivity in process applications where hydrogen is to be accurately monitored. The coatings and the method of manufacture of the coatings provided by the present technique will accurate hydrogen content without interference from harsh background contaminants. The present technique also enables hydrogen content in chemical process streams to be accurately regulated, thereby providing substantial cost savings to industrial chemical operations involving the production of hydrogen-containing streams.

Dissolved Gas Measurement by Direct Immersion of Sensor in Oil with Coating 1

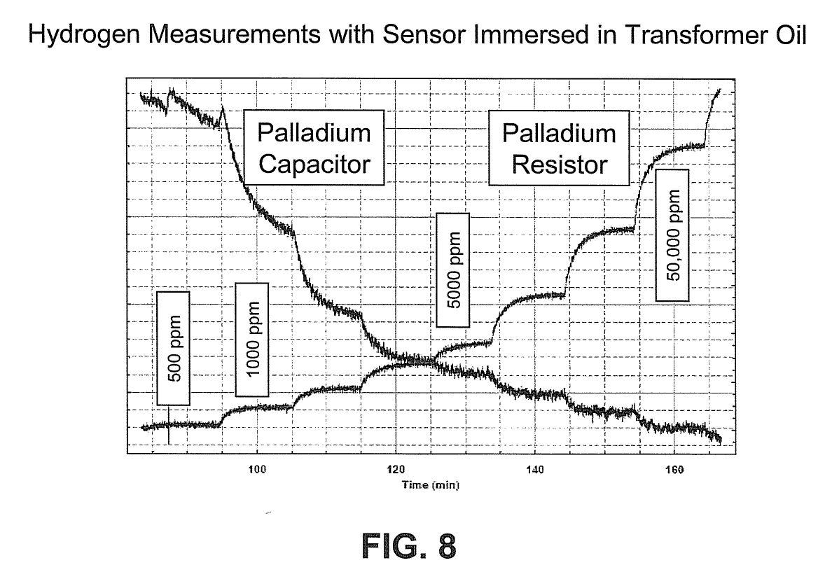

FIG. 8 shows the operation of a protected palladium-nickel hydrogen sensor while immersed in a hydrocarbon oil used to insulate electrical equipment. It is known that exposed palladium will react with hydrocarbons to degrade the oil and/or inhibit the operation of the sensor by fouling with surface carbon.

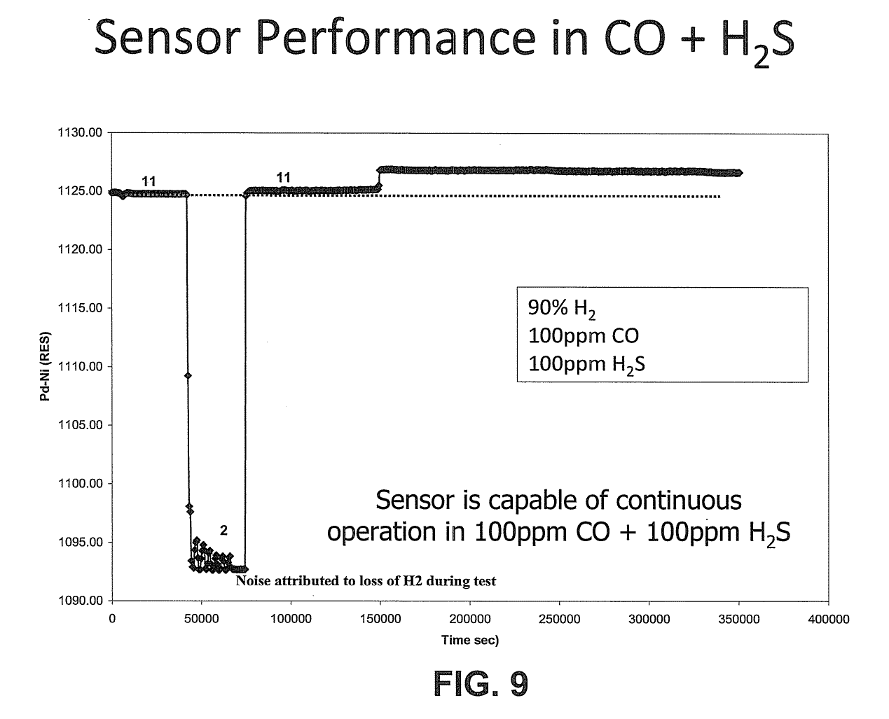

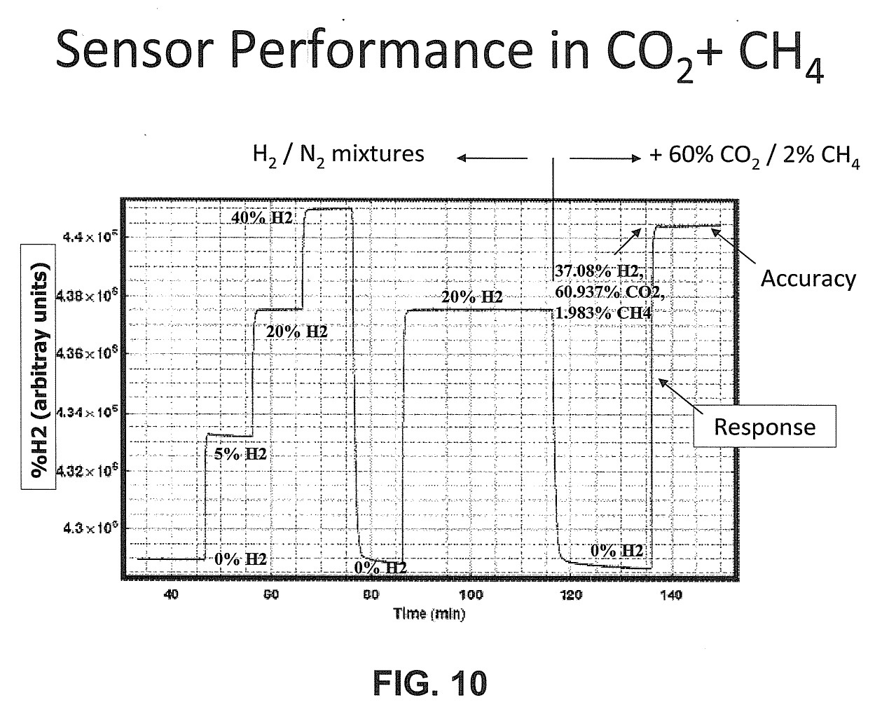

FIG. 9 is a graph showing the effect of Coating 1 on the performance of a hydrogen sensor in a stream containing 90% H₂, 100 ppm CO and 100 ppm H₂S. The sensor with Coating 1 is capable of continuous operation in 100 ppm Co and 100 ppm H₂S. FIG. 10 is a graph showing the effect of Coating 1 on the performance of a hydrogen sensor in a stream containing 60% CO₂ and 2% CH₄. FIGS. 9 and 10 show that the current method and apparatus can be used in a multi component gas stream and in a gas stream with multiple contaminants, such as CO, H₂S, CO₂ and CH₄.

As shown by the data discussed herein, the current coating enables long term performance by the sensor. Long term performance means weeks, months or years of continuous operation without measurable degradation of sensor performance. Previously used coatings could not sustain long term performance by the sensor.

While particular steps, elements, embodiments and applications of the present invention have been shown and described, it will be understood, of course, that the invention is not limited thereto since modifications can be made by those skilled in the art, particularly in light of the foregoing teachings.

What is claimed is:

1. A protective coating for sustaining long term performance of a solid-state sensor of a gaseous constituent in a fluid stream, said sensor comprising a catalyst layer for promoting electrochemical dissociation of said gaseous constituent, said coating comprising at least one layer of silicon dioxide.

2. The protective coating of claim 1 wherein said coating comprises annealed silicon dioxide.

3. The protective coating of claim 2 further comprising at least one layer of a hydrophobic composition for inhibiting diffusion of water through said protective coating to said catalyst layer.

4. The protective coating of claim 3 wherein said hydrophobic composition comprises polytetrafluoroethylene.

5. The protective coating of claim 3 further comprising at least one layer of alumina for inhibiting diffusion of oxygen through said protective coating to said catalyst layer.

6. A protective coating for sustaining long term performance of a solid-state sensor of hydrogen in the presence of fluid hydrocarbons as well as contaminants, said sensor comprising a catalyst layer for promoting electrochemical dissociation of hydrogen, said coating comprising at least one layer of silicon dioxide.

7. The protective coating of claim 6 wherein said coating comprises annealed silicon dioxide.

8. The protective coating of claim 7 further comprising at least one layer of a hydrophobic composition for inhibiting diffusion of water through said protective coating to said catalyst layer.

9. The protective coating of claim 8 wherein said hydrophobic composition comprises polytetrafluoroethylene.

10. The protective coating of claim 8 further comprising at least one layer of alumina for inhibiting diffusion of oxygen through said protective coating to said catalyst layer.

11. A method of manufacturing a solid-state sensor capable of long term performance having a protective coating, said sensor comprising a catalyst layer for promoting electrochemical dissociation of hydrogen present in a fluid stream, said catalyst susceptible to deterioration in the presence of at least one contaminant when present in said fluid stream, said manufacturing method comprising applying at least one layer of silicon dioxide to said sensor, said at least one silicon dioxide layer permitting hydrogen to diffuse through said at least one silicon dioxide layer to said catalyst layer, said at least one silicon dioxide layer inhibiting said at least one contaminant from diffusing through said at least one silicon dioxide layer to said catalyst layer.

12. The manufacturing method of claim 11 further comprising annealing said at least one silicon dioxide layer.

13. The manufacturing method of claim 12 wherein said annealing is performed at about 350° C. in a nitrogen environment.

14. The manufacturing method of claim 11 wherein said at least one silicon dioxide layer is applied by thermal evaporation.

15. The manufacturing method of claim 11 wherein said at least one contaminant is selected from the group consisting of carbon monoxide, hydrogen sulfide, chlorine, oxygen, carbon dioxide, hydrochloric acid, methane, ammonia and water.

16. The manufacturing method of claim 15 further comprising applying at least one layer of a hydrophobic composition to said sensor, said at least one hydrophobic composition layer having a thickness sufficient to inhibit water from diffusing to said catalyst.

17. The manufacturing method of claim 16 wherein said hydrophobic composition comprises polytetrafluoroethylene.

18. The manufacturing method of claim 16 further comprising applying at least one layer of alumina to said sensor, said at least one alumina layer having a thickness sufficient to inhibit oxygen from diffusing to said catalyst.

19. A protectively-coated solid-state sensor capable of long term performance comprising a catalyst layer for promoting electrochemical dissociation of hydrogen present in a fluid stream, said catalyst susceptible to deterioration in the presence of at least one contaminant when present in said fluid stream, said sensor having at least one layer of silicon dioxide applied thereto, said at least one silicon dioxide layer permitting hydrogen to diffuse through said at least one silicon dioxide layer to said catalyst layer, said at least one silicon dioxide layer inhibiting said at least one contaminant from diffusing through said at least one silicon dioxide layer to said catalyst layer.

20. The coated sensor of claim 19 wherein said catalyst layer comprises at least one of palladium and palladium-nickel, and said at least one contaminant is selected from the group consisting of carbon monoxide, hydrogen sulfide, chlorine, oxygen and water.

21. The coated sensor of claim 20 further comprising at least one layer of a hydrophobic composition, said at least one hydrophobic composition layer having a thickness sufficient to inhibit water from diffusing to said catalyst.

22. The coated sensor of claim 21 wherein said hydrophobic composition comprises polytetrafluoroethylene.

23. The coated sensor of claim 21 further comprising at least one layer of alumina, said at least one alumina layer having a thickness sufficient to inhibit oxygen from diffusing to said catalyst.

24. A method of sustaining long term performance of a solid-state hydrogen sensor comprising a catalyst layer for promoting electrochemical dissociation of hydrogen present in a fluid stream, said catalyst susceptible to deterioration in the presence of at least one contaminant when present in said fluid stream, said method comprising applying at least one layer of silicon dioxide to said sensor, said at least one silicon dioxide layer permitting hydrogen to diffuse through said at least one silicon dioxide layer to said catalyst layer, said at least one silicon dioxide layer inhibiting said at least one contaminant from diffusing through said at least one silicon dioxide layer to said catalyst layer.

25. The method of claim 24 further comprising annealing said at least one silicon dioxide layer.

26. The method of claim 25 wherein said annealing is performed at about 350° C. in a nitrogen environment.

27. The method of claim 24 wherein said at least one silicon dioxide layer is applied by thermal evaporation.

28. The method of claim 24 wherein said catalyst layer comprises at least one of palladium and palladium-nickel, and said at least one contaminant is selected from the group consisting of carbon monoxide, hydrogen sulfide, chlorine, oxygen and water.

29. The coated sensor of claim 28 further comprising at least one layer of a hydrophobic composition, said at least one hydrophobic composition layer having a thickness sufficient to inhibit water from diffusing to said catalyst.

30. The coated sensor of claim 29 wherein said hydrophobic composition comprises polytetrafluoroethylene.

31. The coated sensor of claim 29 further comprising at least one layer of alumina, said at least one alumina layer having a thickness sufficient to inhibit oxygen from diffusing to said catalyst.

32. A method of manufacturing a solid-state sensor capable of long term performance having a protective coating, said sensor comprising a catalyst layer for promoting electrochemical dissociation of hydrogen present in a fluid stream, said catalyst susceptible to deterioration in the presence of liquid hydrocarbons when present in said fluid stream, said manufacturing method comprising applying at least one layer of silicon dioxide to said sensor, said at least one silicon dioxide layer permitting hydrogen to diffuse through said at least one silicon dioxide layer to said catalyst layer, said at least one silicon dioxide layer inhibiting said liquid hydrocarbons from diffusing through said at least one silicon dioxide layer to said catalyst layer.

33. A protectively-coated solid-state sensor capable of long term performance comprising a catalyst layer for promoting electrochemical dissociation of hydrogen present in a fluid stream, said catalyst susceptible to deterioration in the presence of liquid hydrocarbons when present in said fluid stream, said sensor having at least one layer of silicon dioxide applied thereto, said at least one silicon dioxide layer permitting hydrogen to diffuse through said at least one silicon dioxide layer to said catalyst layer, said at least one silicon dioxide layer inhibiting said liquid hydrocarbons from diffusing through said at least one silicon dioxide layer to said catalyst layer.
